(19) United States
(12) Patent Application Publication
(10) Pub. No.: US 2009/0011794 A1
(43) Pub. Date: Jan. 8, 2009

(54) INTERFACE METHOD AND APPPARATUS FOR A MOBILE TERMINAL

(75) Inventor: Min-cheol Seo, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/969,987

(22) Filed: Jan. 7, 2008

(30) Foreign Application Priority Data
Jul. 6, 2007 (KR) 2007-68188

(51) Int. Cl. H04M 1/00; G06F 3/00

(52) U.S. Cl. 455/557; 710/20

(57) ABSTRACT

A data-processing/interface method and apparatus in a mobile terminal that is connected to an external audio visual (AV) device using a standard interface, such as Universal Serial Bus (USB). The method includes determining whether an external AV device is connected according to a predetermined interface standard in an external device connection mode, decoding a multimedia file stored in a storage medium and transmitting the decoded multimedia signal to the external AV device according to the predetermined interface standard, and in an external device non-connection mode decoding a multimedia file stored in the storage medium and performing a digital-to-analog conversion of the decoded multimedia signal.

### CROSS-REFERENCE TO RELATED APPLICATIONS

This application claims the benefit of Korean Patent Application No. 10-2007-0068188, filed on Jul. 6, 2007, in the Korean Intellectual Property Office, the disclosure of which is incorporated herein in its entirety by reference.

### BACKGROUND OF THE INVENTION

1. Field of the Invention

The present general inventive concept relates to an interface system between a mobile terminal and an audio/visual (AV) device, and more particularly, to an interface method and apparatus of a mobile terminal connected to an external AV device.

2. Description of the Related Art

Usually, mobile terminals, such as cellular phones, have a phone call function and a music play function. Such mobile terminals having the music play function can reproduce various types of music data, such as MPEG audio-3 (MP3) data and Windows Media Audio (WMA) data.

Conventional mobile terminals having the music play function must use a speaker disposed therein or be connected to hands-free wireless or wired earphones in order for a user to listen to the music.

However, such conventional mobile terminals cannot be used for long periods of time due to limited battery power and do not provide a method of connecting to a car or home audio/visual (AV) system.

### SUMMARY OF THE INVENTION

The present general inventive concept provides an interface method and apparatus in a mobile terminal to transmit music, which is being reproduced, to an external audio/visual (AV) device by connecting to the external AV device via a Universal Serial Bus (USB) and switching to a hands-free mode when an incoming call occurs while playing the music.

The present general inventive concept also provides a mobile terminal to transmit and to receive an audio signal to and from an external audio/visual (AV) device via a Universal Serial Bus (USB) according to a music transmission mode and a hands-free mode.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an interface method of a mobile terminal, the method including determining whether an external audio/visual (AV) device is connected to the mobile terminal according to a predetermined interface standard protocol, decoding a multimedia file stored in a storage medium and transmitting the decoded multimedia signal to the external AV device when in an external device connection mode, according to the predetermined interface standard protocol, decoding a multimedia file stored in the storage medium and performing digital-to-analog conversion of the decoded multimedia signal when in an external device non-connection mode.

The interface method, where the predetermined interface standard protocol may be Universal Serial Bus (USB) protocol.

The interface method, where the external AV device may be a multimedia recording/reproducing device having a USB host function.

The interface method, where the control signal may be an operational control signal generated by the mobile terminal.

The interface method, where the decoded multimedia signal may be transmitted to the external AV device in an isochronous transfer method.

The interface method, where the multimedia file may be encrypted and the encrypted multimedia file may be decrypted and decoded and transmitted to the external AV device.

The foregoing and/or other aspects and utilities of the present general inventive concept may also be achieved by providing an interface method of a mobile terminal connected to an external audio/visual (AV) device, the method including receiving a control signal through an interface according to a predetermined interface standard protocol, and accessing a multimedia file stored in a storage medium according to the received control signal, and transmitting the accessed multimedia file to the external AV device.

The mobile terminal may be an MP3 player.

The mobile terminal may be a cellular phone having a music play function.

The interface method, where the control signal may be a control command received from the external AV device

The foregoing and/or other aspects and utilities of the present general inventive concept may also be achieved by providing an interface method of a mobile terminal, the method including receiving audio data in the mobile terminal, receiving a control signal from an external audio/visual (AV) device connected to the mobile terminal according to a predetermined interface standard protocol, and transmitting the received audio data to the external AV device in response to the control signal received from the external AV device.

The interface method, where it may be determined whether an incoming phone call signal is present, and informing the external AV device of the incoming phone call signal if the incoming call signal is present at the mobile terminal.

The interface method, where the control signal may be a command to switch operation to a hands-free mode.

The interface method, where if a control signal is received from the external AV device, a response control signal is transmitted to the external AV device from the mobile terminal.

The interface method may further include generating a background sound for a phone call by synthesizing audio data received by the mobile terminal from the external AV device and an audio signal read from a storage medium.

The foregoing and/or other aspects and utilities of the present general inventive concept may also be achieved by providing a mobile terminal including a storage medium to store a multimedia file encoded according to a predetermined format, a decoder to decode a multimedia file stored in the storage medium using a predetermined decoding algorithm, an input/output switching unit to switch an input of data and an output of data decoded by the decoder, according to a switching control signal, an interface device to interface the data switched by the input/output switching unit from and to an external audio/visual (AV) device based on an interface standard protocol, and a controller to control the transmission of decoded data to the external AV device via the interface device if the mobile terminal is connected to the external AV device, or to control the playing of the decoded data in the mobile terminal if the mobile terminal is not connected to the external AV device, and the controller generates an appropriate switching control signal to control the input/output switching unit according to whether or not the mobile terminal is connected to the external AV device.

The mobile terminal, where the controller may respectively transmit and receive a data control signal to and from the external AV device via the interface device if the mobile terminal is connected to the external AV device.

The mobile terminal, where the controller may control the transmission of audio data received by the mobile terminal in a wireless manner to an external AV device connected to the mobile terminal according to a predetermined interface standard protocol in response to a control signal received from the external AV device.

The mobile terminal, where the interface device may transmit the decoded output of data to the external AV device in an isochronous transfer method.

The foregoing and/or other aspects and utilities of the present general inventive concept may also be achieved by providing a multimedia interface system, including a mobile telecommunications device having a music play function and a storage medium to store multimedia data signals, a host device having a user interface to enter commands to control access to multimedia data signals stored in the storage medium, the host device being connected to the mobile terminal, and an interface between the mobile terminal and the host device to provide transfers of the multimedia data from the mobile terminal to the host device, to provide transfers of audio data from the host device to the mobile terminal, and to provide transfers of control signals between the mobile terminal and the host device for the data transfers.

The multimedia interface system, where the mobile telecommunications device and the host device may be connected via a wireless connection.

The multimedia interface system, where the mobile telecommunications device and the host device may selectively transfer multimedia information and/or phone call information according to whether the mobile telecommunications device is in a music mode or a phone call hands-free mode.

The multimedia interface system, where the host device may initiate a phone call mode of the multimedia interface system.

The multimedia interface system, where the mobile telecommunications device may initiate a phone call mode of the multimedia interface system.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a conceptual diagram of an interface system between a mobile terminal and an external Universal Serial Bus (USB) audio/visual host device, according to an embodiment of the present general inventive concept;

FIG. 2A is a block diagram of the mobile terminal illustrated in FIG. 1, according to an embodiment of the present general inventive concept;

FIG. 2B is a block diagram of the USB host device illustrated in FIG. 1, according to an embodiment of the present general inventive concept;

FIG. 3 is a block diagram illustrating a music play operation in a normal mode of the mobile terminal of FIG. 1, according to an embodiment of the present general inventive concept;

FIG. 4 is a block diagram illustrating a data transmission and reception operation when the mobile terminal of FIG. 1 is connected to the USB host device of FIG. 1, according to an embodiment of the present general inventive concept;

FIG. 5 is a block diagram illustrating an operation in a phone call hands-free mode when the mobile terminal of FIG. 1 is connected to the USB host device of FIG. 1, according to an embodiment of the present general inventive concept; and

FIG. 6 is a flowchart of an interface method of a mobile terminal according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

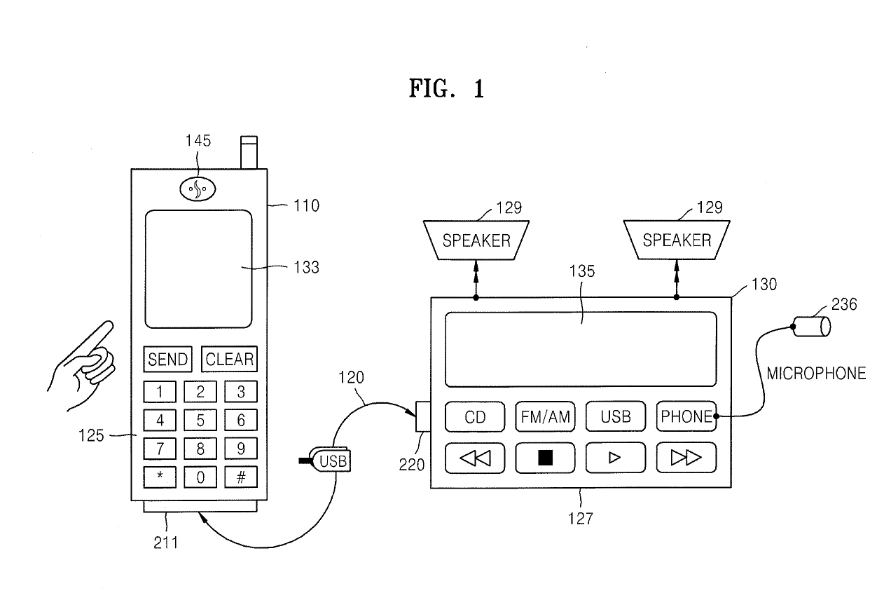

FIG. 1 is a conceptual diagram of an interface system between a mobile terminal 110, which may be a mobile telecommunications device such as a mobile phone, and a Universal Serial Bus (USB) host device 130, which is an external audio/visual (AV) device, according to an embodiment of the present general inventive concept. USB is a peripheral interface standard protocol and is a plug & play interface to provide communication between a host terminal and a peripheral device.

In the interface system illustrated in FIG. 1, the mobile terminal 110 and the USB host device 130 are connected to each other via a USB cable 120 that can be implemented in a wired manner as described herein, or can be implemented in a wireless manner via a wireless connection using, for example, a Bluetooth® connection.

Referring to FIG. 1, the mobile terminal 110 performs a multimedia reproduction function including a music play function and a phone call function. For example, the mobile terminal 110 may be a cellular phone having a music play function or may be an MP3 player having a music play function. In addition, the mobile terminal 110 has a USB interface which includes a USB connector 211, and may receive and transmit a control signal (or control command) and audio data from and to the USB host device 130 via the USB interface. An interface method according to an embodiment of the present general inventive concept is not limited to an interface which supports a specific protocol to communicate with a certain device.

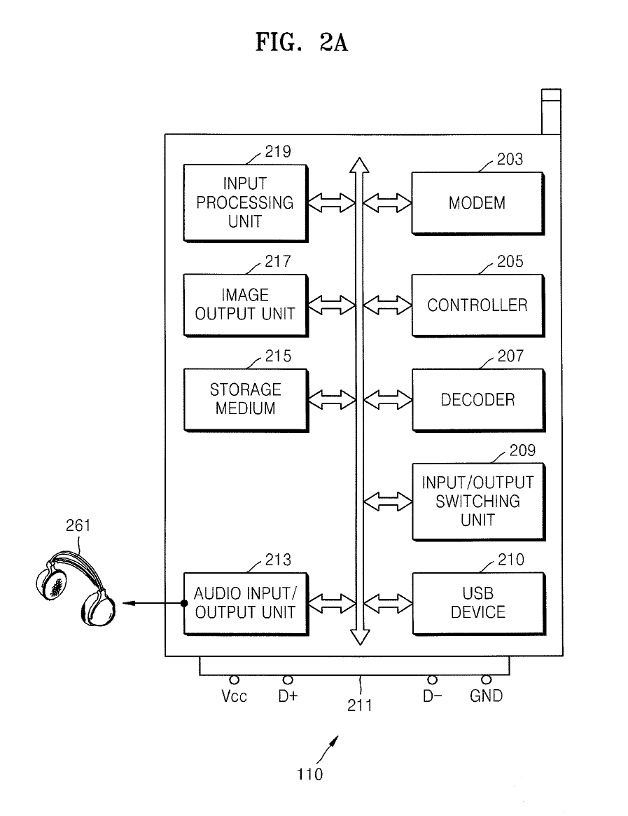

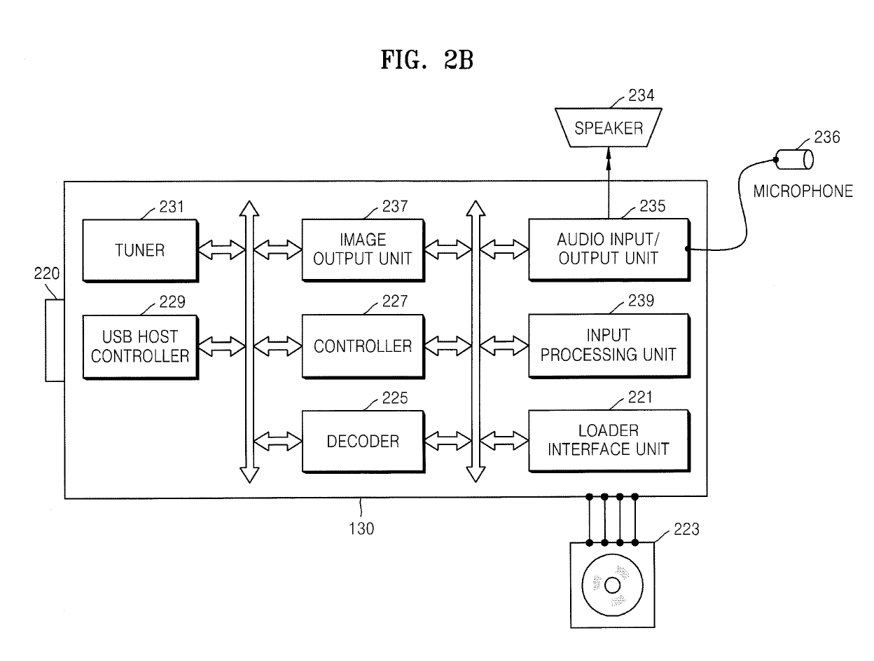

The mobile terminal 110 performs different audio data processing functions according to whether the mobile terminal 110 is connected to the USB host device 130 via the USB interface. That is, in a mode in which the mobile terminal 110 is connected to the USB host device 130 via the USB interface, the mobile terminal 110 decodes a multimedia file stored in a storage medium 215 (refer to FIG. 2A) of the mobile terminal 110 and transmits a corresponding decoded multimedia signal to the USB host device 130 in an isochronous (that is, time dependent) transfer method.

In a normal mode in which the mobile terminal 110 is not connected to the USB host device 130, the mobile terminal 110 decodes a multimedia file stored in the storage medium 215 of the mobile terminal 110 and outputs a corresponding decoded multimedia signal to an internal speaker 145 of the mobile terminal 110 or to a user listening device 261 (refer to FIG. 2A) which may be headphones or another removable wired user audio listening device, such as one or more ear buds, or may be a wireless listening device (for example, a Bluetooth® device).

The USB host device 130 has a USB host interface which includes USB connector 220 and may play and/or record an audio/video signal received from another USB device via the USB host interface.

In one embodiment, the mobile terminal 110 receives and transmits control and audio data from and to the USB host device 130 via the USB cable 120. That is, the mobile terminal 110 is connected to the USB host device 130 via the USB cable 120, the USB connector 211 and the USB connector 220, where the USB connector 211 of the mobile terminal 110 and the USB connector 220 of the USB host device 130 each include a power terminal Vcc, a ground terminal GND, a first data terminal D+, and a second data terminal D− (refer to FIG. 2A which illustrates this terminal arrangement for the USB connector 211, and although not illustrated, the arrangement for USB connector 220 is similar).

The USB host device 130 can control the mobile terminal 110 using a user interface 127, which includes one or more input buttons and/or a touch screen or display 135. For example, the USB host device 130 can perform various play-related control functions, including play, stop, pause, next file play, and previous file play, and a control function of searching for content stored in the mobile terminal 110. These control functions can be implemented through a Human Interface Device (HID) class of a USB forum, or through a vendor class defined by each manufacturer.

In addition, when an incoming phone call is received by the mobile terminal 110, the connected USB host device 130 can switch to a phone call hands-free mode to continue the phone call using audio input and output members of the USB host device 130, such as speakers 129 and a microphone 236.

FIG. 2A is a block diagram of the mobile terminal 110 illustrated in FIG. 1, according to an embodiment of the present general inventive concept.

Referring to FIG. 2A, the mobile terminal 110 includes a modem 203, a controller 205, a decoder 207, an input/output switching unit 209, a USB device 210, a USB connector 211, an audio input/output unit 213, a storage medium 215, an image output unit 217, and an input processing unit 219.

The input processing unit 219 has a plurality of function buttons including, for example, those illustrated of the user interface 125 of FIG. 1, and processes a control command input by a user on the user interface 125. The control command may also be input by the user on the display 133 which may be touchscreen.

The modem 203 modulates and demodulates respective transmitted and received signals for any of a plurality of possible wireless telecommunication standards using a Code Division Multiple Access (CDMA), a Universal Mobile Telecommunications System (UMTS), and/or a Global System for Mobile Communication (GSM) transceiver module (not illustrated), and/or a transceiver module that supports any other wireless telecommunication standard for mobile communication (not illustrated).

The image output unit 217 displays cellular phone information and music-related image information on a display 133 of FIG. 1, which may be, for example, a Liquid Crystal Display (LCD), a light emitting diode (LED) display, or a touchscreen.

The storage medium 215 includes a Hard Disk Drive (HDD), a flash memory, or any other large capacity storage medium which may be removable, and stores a multimedia file on the storage medium 215 encoded in a predetermined format.

The decoder 207 decodes a multimedia file selected from the storage medium 215 under control of the controller 205 using a predetermined decoding algorithm.

The input/output switching unit 209 switches, or controls, an input and an output of data according to a switching control signal from the controller 205 and may include analog to digital and digital to analog conversion functions.

The audio input/output unit 213 converts an audio input/output signal to a corresponding audio digital/analog signal.

The USB device 210 transmits decoded multimedia data to the USB host device 130 and receives control information from the USB host device 130 via the USB connector 211 and the USB cable 120 according to a USB standard protocol.

The USB connector 211, as described above, includes connection terminals according to the USB standard. For example, the USB connector 211 includes a power terminal Vcc, a ground terminal GND, a first data terminal D+, and a second data terminal D−, as illustrated.

The controller 205 senses whether there is a connection between the mobile terminal 110 and the USB host device 130 via the USB device 210, and if the USB host device 130 is sensed by the controller 205 as being connected to the mobile terminal 110, the controller 205 accesses and decodes a multimedia file stored in the storage medium 215 of the mobile terminal 110 and transmits the decoded multimedia signal to the USB host device 130 via the USB device 210. If the multimedia file is encrypted, the controller 205 decrypts and decodes the encrypted multimedia file before transmitting the decoded multimedia signal. In addition, if an incoming phone call occurs while playing music, the controller 205 generates a ring signal and switches to the phone call hands-free mode. In addition, in the normal mode of playing music, where the mobile terminal 110 is not connected to the USB host device 130, the mobile terminal 110 decodes a multimedia file stored in the storage medium 215 and outputs the decoded multimedia signal to the audio input/output unit 213 to be output to the user listening device 261.

FIG. 2B is a block diagram of the USB host device 130 illustrated in FIG. 1, according to an embodiment of the present general inventive concept.

Referring to FIG. 2B, the USB host device 130 includes the USB connector 220, a loader interface unit 221, a loader 223, a decoder 225, a controller 227, a USB host controller 229, a tuner 231, a speaker 234, an audio input/output unit 235, a microphone 236, an image output unit 237, and an input processing unit 239.

The audio input/output unit 235 inputs or outputs an audio signal, respectively, from the microphone 236 or to the speaker 234.

The input processing unit 239 has a plurality of function buttons (for example, those of the user interface 127 illustrated in FIG. 1) and/or a display 135 (refer to FIG. 1) which may be a touchscreen, and processes a control command input by a user on one or more of the function buttons and/or the touchscreen.

The loader 223 receives and loads to play a Compact Disc (CD) or a Digital Versatile Disc (DVD) which includes data representing music and/or video images.

The loader interface unit 221 interfaces with the loader 223 under control of the controller 227.

The decoder 225 decodes a multimedia file using a predetermined decoding algorithm.

The controller 227 controls each functional block of the USB host device 130 illustrated in FIG. 2B.

The image output unit 237 displays video information on the display 135 (refer to FIG. 1), which may be an LCD, an LED display or a touchscreen.

The USB host controller 229 controls a host function, including data flow to and from the USB connector 220, according to the USB standard protocol.

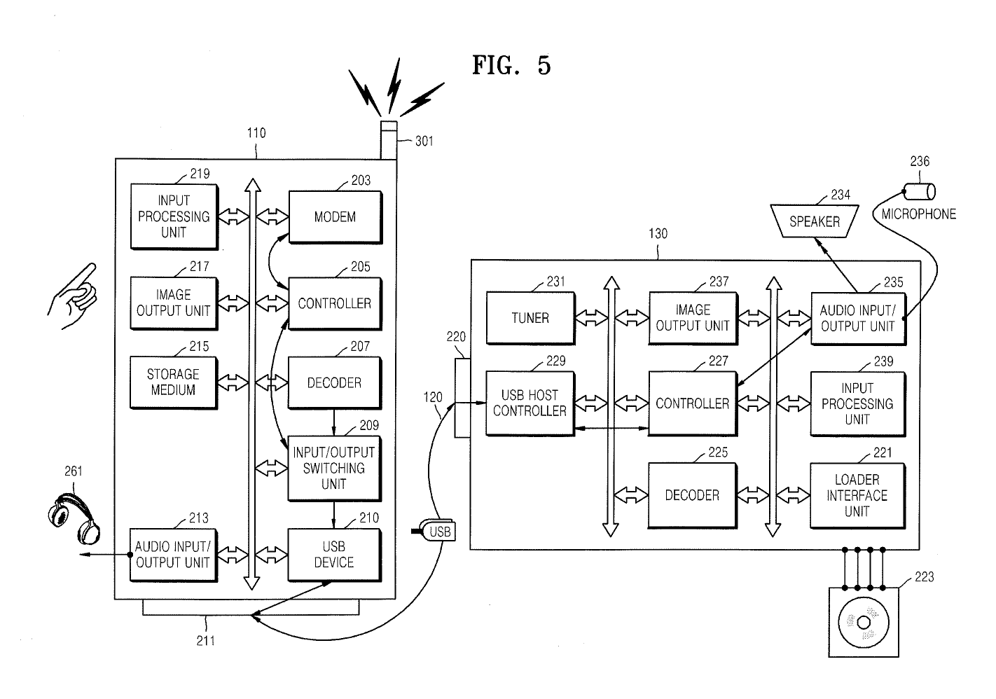

The tuner 231 receives an external Frequency Modulation (FM) or Amplitude Modulation (AM) type signal via an antenna 301 (refer to FIG. 5), according to a tuning control signal from the controller 227.

The USB connector 220 includes connection terminals according to the USB standard. For example, the USB connector 220 includes a power terminal Vcc, a ground terminal GND, a first data terminal D+, and a second data terminal D− similar to those illustrated for the USB connector 211 of the mobile terminal 110 of FIG. 2A.

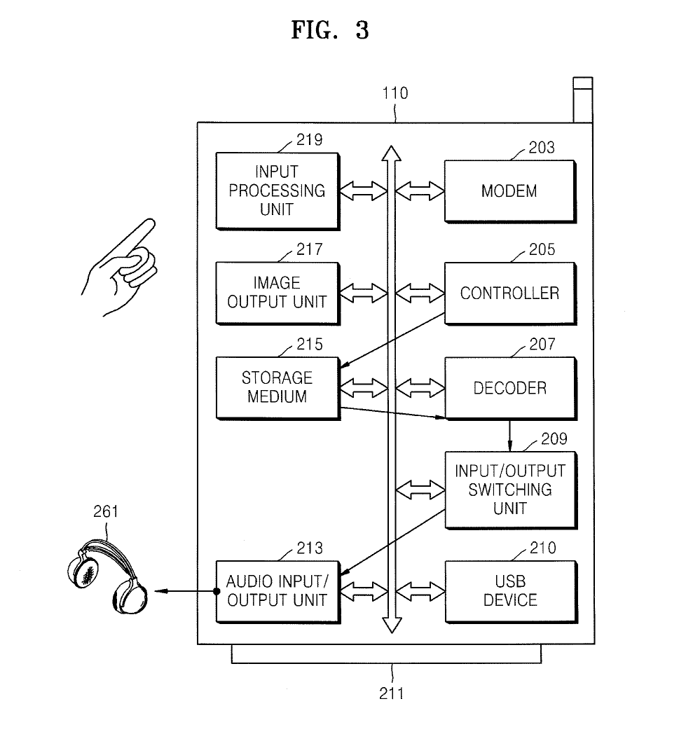

FIG. 3 is a block diagram illustrating a music play operation in the normal mode of the mobile terminal 110, in a case where there is no connection to the USB host device 130, according to an embodiment of the present general inventive concept.

Referring to FIG. 3, the controller 205 of the mobile terminal 110 controls the decoder 207 to decode a multimedia file stored in the storage medium 215 and controls the input/output switching unit 209 to output the decoded multimedia signal to the audio input/output unit 213 by applying a switching control signal to the input/output switching unit 209. Finally, the audio input/output unit 213 outputs the decoded multimedia signal, such as an audio signal, to the user listening device 261. If the decoded multimedia signal is a video signal, it is switched to the image output unit 217.

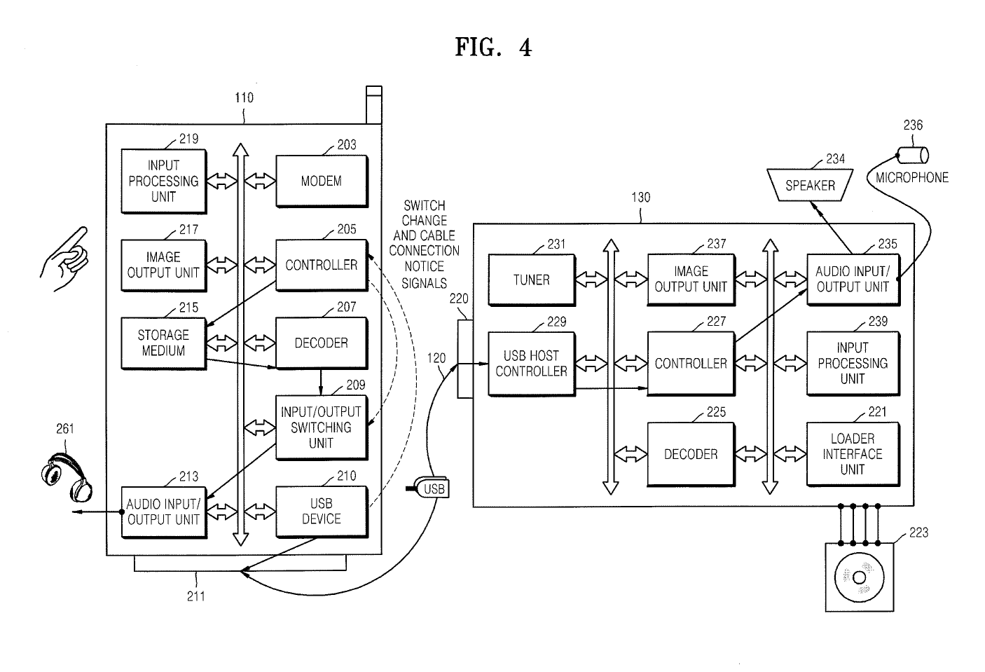

FIG. 4 is a block diagram illustrating a data transmission and reception operation when the mobile terminal 110 is connected to the USB host device 130, according to an embodiment of the present general inventive concept. In FIG. 4, note that data paths are illustrated as solid lines, and control signals are illustrated as broken lines, both types of lines having signal flow direction indicated by arrows.

An operation of the mobile terminal 110 will now be described. If the USB cable 120 is connected to the USB host device 130, a predetermined voltage is applied to the power terminal Vcc of the USB connector 211 (refer to FIG. 2A). If a voltage value greater than a reference voltage is detected by the USB device 210 of the mobile terminal 110, the USB device 210 outputs a cable connection notice signal to the controller 205 to indicate that the USB host device 130 is connected.

The controller 205 transmits the cable connection notice signal to the USB host device 130 via the USB device 210 and the USB cable 120 and changes input/output switching control settings by applying a switching control signal to the input/output switching unit 209.

The controller 205 then controls the decoder 207 to decode a multimedia file stored in the storage medium 215 and controls the input/output switching unit 209 to output the decoded multimedia signal to the USB device 210 by applying the switching control signal to the input/output switching unit 209. Finally, the USB device 210 transmits the decoded multimedia signal, such as a video signal and/or an audio signal, to the USB host device 130 via the USB cable 120.

An operation of the USB host device 130 will now be described for this embodiment.

The USB host controller 229 receives audio data and/or video data output from the mobile terminal 110 via the USB connector 220. The controller 227 outputs the received audio data to the audio input/output unit 235, outputs the received video data to the image output unit 237, and transmits to the mobile terminal 110 a control command which has been input through the user interface 127 (refer to FIG. 1) or the display 135 of the USB host controller 229 by a user or a control signal which has been generated by the USB host device 130 to the mobile terminal 110. The audio input/output unit 235 outputs the received audio data to the speaker 234.

FIG. 5 is a block diagram illustrating an operation in the phone call hands-free mode when the mobile terminal 110 is connected to the USB host device 130, according to an embodiment of the present general inventive concept. In FIG. 5, note that data paths are illustrated as solid lines having data flow direction indicated by arrows. In another embodiment, an operation in the phone call hands-free mode may be initiated by a phone call command being input via the “Phone” function button of the user interface 127 of the USB host device 130. The various control signal paths and data paths between functional blocks in the USB host device 130 and to and from the mobile terminal 110 in such an embodiment are similar to those described below for the operation of the mobile terminal 110 when mobile terminal 110 initiates the phone call hands-free mode.

An operation of the mobile terminal 110 will now be described for this embodiment.

If an incoming phone call signal is received via an antenna 301 of the mobile terminal 110, the modem 203 demodulates the phone call signal, which is the incoming signal, to an audio signal. The controller 205 changes the operation mode from music play mode into the phone call hands-free mode and controls the input/output switching unit 209 to output a phone call audio signal to the USB device 210 that then transmits the phone audio signal to the USB host device 130 via the USB cable 120.

A phone call audio signal for the phone call originating in the USB host device 130, via microphone 236, is transmitted to the mobile terminal 110 via the USB cable 120, and more particularly to modem 203 via the USB device 210, and to the input/output switching unit 209 and the controller 205 of the mobile terminal 110. The modem 203 modulates the phone call audio signal received from the USB host device 130 to a Radio Frequency (RF) signal and outputs the RF signal through the antenna 301.

An operation of the USB host device 130 will now be described for this embodiment.

The USB host controller 229 receives a phone call audio signal from the mobile terminal 110 via the USB cable 120 and the USB connector 220. The controller 227 outputs the received phone call audio signal to the audio input/output unit 235 that then outputs the phone call audio signal to the speaker 234.

A phone call audio signal received from the microphone 236 is transmitted to the mobile terminal 110 via the audio input/output unit 235, the controller 227, and the USB host controller 229 of the USB host device 130, as described above. The controller 227 transmits a control command which has been input through the user interface 127 (refer to FIG. 1) or a control signal generated by the USB host device 130 to the mobile terminal 110 via the USB connector 220.

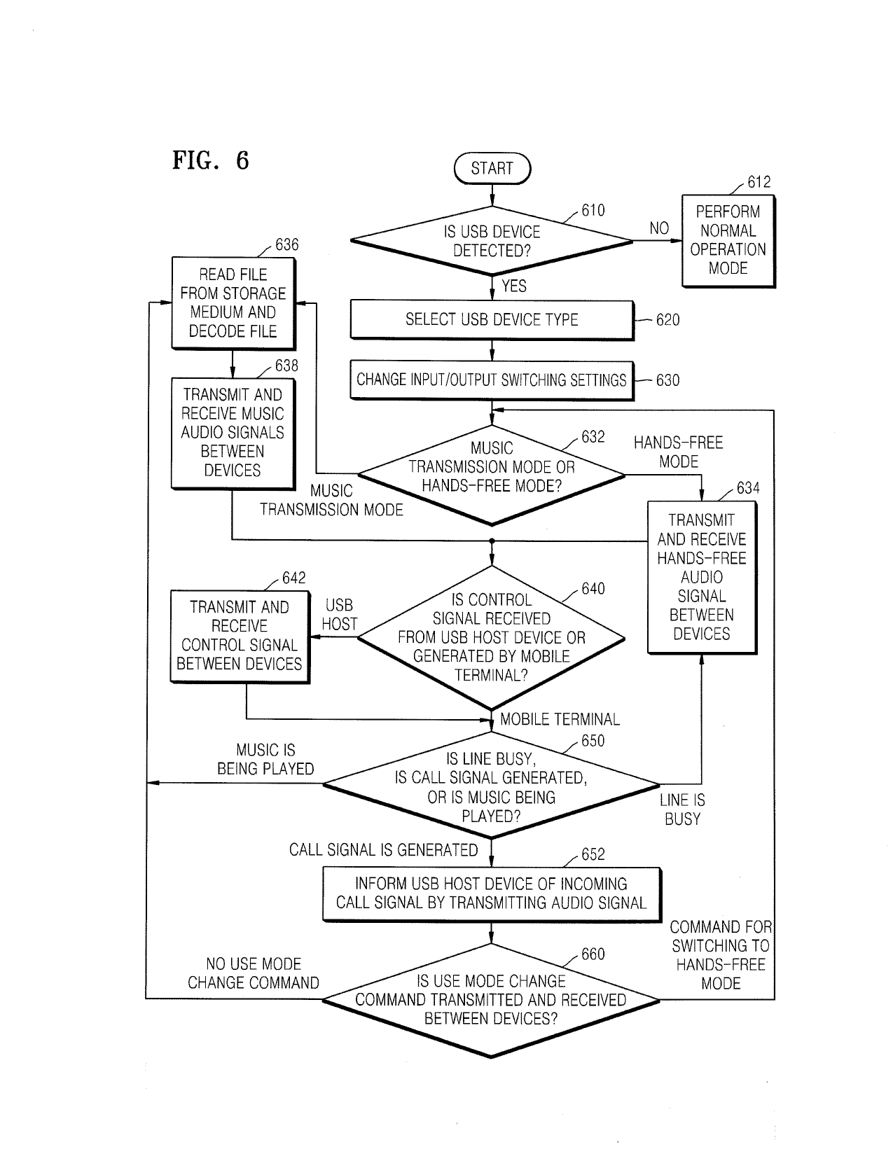

FIG. 6 is a flowchart of an interface method of a mobile terminal according to an embodiment of the present general inventive concept.

Referring to FIG. 6, the mobile terminal determines in operation 610 whether a USB device is detected via a USB cable connected to the mobile terminal. In this case, the USB device includes a USB portable storage device or a USB host device. For example, if a USB cable is connected, the mobile terminal can sense the connection by sensing a voltage that is applied through a power terminal of a USB connector of the USB cable or by sensing an interrupt signal that is input from a USB device corresponding to a connected external interface device.

However, if the mobile terminal cannot detect a connected USB device the mobile terminal performs in a normal operation mode in operation 612. For example, in the normal operation mode, the mobile terminal decodes a multimedia file stored in a storage medium, performs a digital-to-analog conversion of the decoded multimedia signal, and outputs the converted signal to an external user listening device or to an internal speaker of the mobile terminal.

If the mobile terminal detects a connected USB device, the mobile terminal selects a USB device type which corresponds to the USB device which is connected according to a command input by a user in operation 620. For example, the user can select any one of a USB portable storage device or a USB host device which is connected to the mobile terminal via the USB cable. The mobile terminal may also perform the selection of the USB device type without input from the user. Hereinafter, it is assumed that the mobile terminal is connected to a USB host device which as been selected.

The mobile terminal changes input/output switching control settings in order to transmit and to receive a signal to and from, respectively, the USB host device in operation 630.

The mobile terminal determines whether it is operating in a music transmission mode or a phone call hands-free mode using control state information of the mobile terminal, such as an operational control state register value, in operation 632.

In the music transmission mode, the mobile terminal reads and decodes a multimedia file stored in the storage medium for a video and/or an audio signal using a predetermined decoding algorithm in operation 636. The mobile terminal transmits the decoded audio signal for music and/or the decoded video signal to the USB host device, or receives a phone call audio signal originating from the USB host device, in operation 638. For example, the mobile terminal can transmit an audio signal for selected music to the USB host device via the USB cable, and may also record an FM radio signal received from the USB host device to play the recorded FM radio signal any time it is selected by a user.

In the phone call hands-free mode, the mobile terminal transmits or receives a phone call hands-free audio signal to or from the USB host device in operation 634.

The USB host device determines, in operation 640, whether a control signal which has been input by the user or has been generated by the USB host device has been respectively input or generated in the music transmission mode or in the phone call hands-free mode.

If the USB host device has generated the control signal, a control command is transmitted by the USB host device and received by the mobile terminal which in response generates an operational control signal, in operation 642. The control command includes various play-related controls, such as play, stop, pause, next file play, and previous file play, and a content search control. For example, if the USB host device generates a control command corresponding to “play”, the mobile terminal receives the control command corresponding to “play” and transmits an operational control signal to the USB host device in response to the “play” control command.

The mobile terminal determines the state of operation in operation 650 using mobile terminal control state information, such as an operational state register value, to determine whether the phone line is busy, whether an incoming phone call signal has been input, or whether music is being played. In another embodiment, the mobile terminal can detect an incoming phone call signal using an interrupt signal generated by a modem.

If it is determined by the mobile terminal that music is being played, the mobile terminal performs operations 636 and 638 in the music transmission mode according to the control signal received from the USB host device.

If it is determined by the mobile terminal that the phone line is busy, the mobile terminal continues performing operation 634 in the phone call hands-free mode.

If a phone call signal, such as a ring signal, is sensed, the mobile terminal informs the USB host device that an incoming phone call exists by transmitting an audio signal generated by a ring indicator to the USB host device in operation 652. Each of the mobile terminal and the USB host device determines, in operation 660, whether a use mode change command is received or transmitted. For example, if an audio signal, to inform that an incoming phone call from the mobile terminal exists and is received by the USB host device from the mobile terminal, the USB host device then transmits a command signal to switch to the phone call hands-free mode to the mobile terminal. The mobile terminal transmits a response signal to the USB host device in response to the received command signal to switch to the phone call hands-free mode and switches operation to the phone call hands-free mode.

Additionally, the mobile terminal can generate music to be played in the phone call hands-free mode as background music during a phone call. For example, the mobile terminal can generate background music by synthesizing a phone call audio signal received from the USB host device (for example, a voice signal) and an audio signal read from the storage medium (for example, a music signal) and transmitting the synthesized audio/music signal as an phone call with background music signal to a caller's mobile terminal via the modem.

The present general inventive concept can also be embodied as computer-readable codes on a computer-readable medium. The computer-readable medium can include a computer-readable recording medium and a computer-readable transmission medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As described above, according to the present general inventive concept, a user can use a mobile terminal, for example a mobile phone, having a music play function by connecting the mobile terminal to an external device using a USB connection.

In addition, as described above, an interface system can provide an interface to operate a music transmission function and a phone call hands-free function to switch to a phone call mode from a music playing mode when an incoming phone call exists when music is being played.

In addition, in embodiments of the present general inventive concept, power can be transferred between a mobile terminal and an external device, thereby lessening low battery power limitations of a mobile terminal.

Although a few embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. An interface method of a mobile terminal, the method comprising:
determining whether an external audio/visual (AV) device is connected to the mobile terminal according to a predetermined interface standard protocol;
decoding a multimedia file stored in a storage medium and transmitting the decoded multimedia signal to the external AV device when in an external device connection mode, according to the predetermined interface standard protocol; and
decoding a multimedia file stored in the storage medium and performing a digital-to-analog conversion of the decoded multimedia signal when in an external device non-connection mode.

2. The method of claim 1, wherein the predetermined interface standard protocol is Universal Serial Bus (USB) protocol.

3. The method of claim 1, wherein the external AV device is a multimedia recording/reproducing device having a USB host function.

4. The method of claim 1, wherein the decoded multimedia signal is transmitted to the external AV device in an isochronous transfer method.

5. The method of claim 1, wherein the multimedia file is encrypted and the encrypted multimedia file is decrypted and decoded and transmitted to the external AV device.

6. An interface method of a mobile terminal connected to an external audio/visual (AV) device, the method comprising:
receiving a control signal through an interface according to a predetermined interface standard protocol
accessing a multimedia file stored in a storage medium according to the received control signal; and
transmitting the accessed multimedia file to the external AV device.

7. The method of claim 6, wherein the mobile terminal is an MP3 player.

8. The method of claim 6, wherein the mobile terminal is a cellular phone having a music play function.

9. The method of claim 6, wherein the predetermined interface standard protocol is Universal Serial Bus (USB) protocol.

10. The method of claim 6, wherein the control signal is a control command received from the external AV device.

11. An interface method of a mobile terminal, the method comprising:
receiving audio data in the mobile terminal;
receiving a control signal from an external audio/visual (AV) device connected to the mobile terminal according to a predetermined interface standard protocol; and
transmitting the received audio data to the external AV device in response to the control signal received from the external AV device.

12. The method of claim 11, further comprising:
determining whether an incoming phone call signal is present; and
informing the external AV device of the incoming phone call signal if the incoming call signal is present at the mobile terminal.

13. The method of claim 11, wherein the control signal is a command to switch operation to a hands-free mode.

14. The method of claim 11, wherein if a control signal is received from the external AV device, a response control signal is transmitted to the external AV device from the mobile terminal.

15. The method of claim 11, further comprising:
generating a background sound for a phone call by synthesizing audio data received by the mobile terminal from the external AV device and an audio signal read from a storage medium.

16. A mobile terminal comprising:
a storage medium to store a multimedia file encoded according to a predetermined format;
a decoder to decode a multimedia file stored in the storage medium using a predetermined decoding algorithm;
an input/output switching unit to switch an input of data, and an output of data decoded by the decoder, according to a switching control signal;
an interface device to interface the data switched by the input/output switching unit from and to an external audio/visual (AV) device based on an interface standard protocol; and
a controller to control the transmission of decoded data to the external AV device via the interface device if the mobile terminal is connected to the external AV device, or to control the playing of the decoded data in the mobile terminal if the mobile terminal is not connected to the external AV device, and the controller generates an appropriate switching control signal to control the input/output switching unit according to whether or not the mobile terminal is connected to the external AV device.

17. The mobile terminal of claim 16, wherein the controller respectively transmits and receives a data control signal to and from the external AV device via the interface device if the mobile terminal is connected to the external AV device.

18. The mobile terminal of claim 16, wherein the controller controls the transmission of audio data received by the mobile terminal in a wireless manner to an external AV device connected to the mobile terminal according to a predetermined interface standard protocol in response to a control signal received from the external AV device.

19. The mobile terminal of claim 16, wherein the interface device transmits the decoded output of data to the external AV device in an isochronous transfer method.

20. The method of claim 6, wherein the control signal is an operational control signal generated by the mobile terminal.

21. A multimedia interface system, comprising:
a mobile telecommunications device having a music play function and a storage medium to store multimedia data signals;
a host device having a user interface to enter commands to control access to multimedia data signals stored in the storage medium, the host device being connected to the mobile terminal; and
an interface between the mobile terminal and the host device to provide transfers of the multimedia data from the mobile terminal to the host device, to provide transfers of audio data from the host device to the mobile terminal, and to provide transfers of control signals between the mobile terminal and the host device for the data transfers.

22. The multimedia interface system of claim 21, wherein the mobile telecommunications device and the host device are connected via a wireless connection.

23. The multimedia interface system of claim 21, wherein the mobile telecommunications device and the host device selectively transfer multimedia information and/or phone call information according to whether the mobile telecommunications device is in a music mode or a phone call hands-free mode.

24. The multimedia interface system of claim 21, wherein the host device initiates a phone call mode of the multimedia interface system.

25. The multimedia interface system of claim 21, wherein the mobile telecommunications device initiates a phone call mode of the multimedia interface system.
